(19) United States
(12) Patent Application Publication
(10) Pub. No.: US 2026/0124902 A1
(43) Pub. Date: May 7, 2026

(54) WHEEL MODULE AND DRIVE DEVICE INCLUDING SAME

(71) Applicant: HANKOOK TIRE & TECHNOLOGY CO., LTD., Seongnam-si, Gyeonggi-do (KR)

(72) Inventors: Hee Sung JANG, Seoul (KR); Seung Hwan RHEE, Daejeon (KR); A Reum KIM, Seoul (KR)

(21) Appl. No.: 19/117,178

(22) PCT Filed: Sep. 27, 2023
(86) PCT No.: PCT/KR2023/015024

§ 371 Date: Mar. 31, 2025

(30) Foreign Application Priority Data
Sep. 29, 2022 (KR) 10-2022-0123967

(51) Int. Cl. B60K 7/00

(52) U.S. Cl. CPC B60K 7/0007

(57) ABSTRACT

An embodiment provides a wheel module comprising: a body; a connection part which is rotatably coupled to the body, the connection part being rotatable in a first direction; a wheel body which is rotatably coupled to the connection part, the wheel body being rotatable in a second direction; and a wheel part which is arranged to be spaced apart from the wheel body and has an auxiliary tread portion having selectively adjustable internal pressure.

### TECHNICAL FIELD

The present invention relates to a device and, more specifically, to a wheel module and a drive device including the same.

### BACKGROUND ART

Globally, the development of smart cities is planned to address environmental pollution and residential environment problems caused by overpopulation and rapid industrialization. The smart cities refer to small-scale urban environments that aim to enhance the quality of life by establishing an urban ecosystem and advanced infrastructure in environments where human survival was previously difficult, such as tropical rainforests, deserts, or marine areas, addressing the urban housing problem, the environmental problem, and the traffic problem. The smart cities need an efficient driving system capable of free rotation and movement within a confined urban environment of approximately 2 km.

However, conventional circular wheels used in a vehicle require a turning radius of several meters to rotate the vehicle or change lanes, and has another problem in that tires are prone to rapid wear due to continuous friction during rotation and turning. Moreover, drive systems or wheels installed in each vehicle cannot be used in various environments since being fixed in specific sizes according to vehicle specifications. Therefore, in order to overcome the above problems, there is a need for a drive system that can be universally applied in confined spaces and various usage environments.

### DISCLOSURE

### Technical Problem

Accordingly, the present invention has been made in view of the above-mentioned problems occurring in the related art, and it is an object of the present invention to provide a wheel module and a drive device including the same, which can rotate with a small turning radius through multi-axis rotational motion, allow rapid and easy emergency braking in urgent situations, and be applied to various usage environments (or platforms) through a detachable coupling structure.

Technical objects to be achieved by the present invention are not limited to the above-described objects and other technical objects that have not been described will be evidently understood by those skilled in the art from the following description.

### Technical Solution

To accomplish the above-mentioned objects, according to the present invention, there is provided a wheel module including: a body; a connection part rotatably coupled to the body in a first direction; and a wheel part including a wheel body rotatably coupled to the connection part in a second direction, and an auxiliary grounding part spaced apart from the wheel body, wherein the internal pressure of the auxiliary grounding part is selectively adjustable.

In an embodiment of the present invention, the body includes a through-hole penetrating both ends in the vertical direction, and the connection part is arranged inside the through-hole and is rotatably arranged in the inner circumferential direction of the through-hole.

In an embodiment of the present invention, the connection part is rotatably arranged inside the through-hole in a third direction centered on a rotation shaft.

In an embodiment of the present invention, the connection part comprises a connection body, which includes a pair of curved parts curved to correspond to the inner surface shape of the through-hole and facing each other, and a pair of straight parts arranged between the pair of curved parts and extending parallel to each other.

In an embodiment of the present invention, a pair of auxiliary grounding parts are provided, and are arranged on both sides of the wheel body to face each other.

In an embodiment of the present invention, the wheel module further includes: a first drive part arranged in the body and generating a driving force to rotate the connection part in the first direction; a second drive part arranged inside the wheel body and generating a driving force to rotate the wheel part in the second direction; and a third drive part arranged in the body and generating a driving force to rotate the connection part in the third direction.

In an embodiment of the present invention, the wheel module further includes a sensor unit for measuring a rotation angle of the wheel part and a rotation angle of the connection part.

In an embodiment of the present invention, the wheel module further includes a shock absorption part arranged at the upper portion of the body to absorb external shocks.

In another aspect of the present invention, there is provided a drive device including: a wheel module; and a driving body to which at least one wheel module is coupled at a lower portion. The wheel module includes: a body; a connection part rotatably coupled to the body in a first direction; and a wheel part including a wheel body rotatably coupled to the connection part in a second direction, and an auxiliary grounding part spaced apart from the wheel body, wherein the internal pressure of the auxiliary grounding part is selectively adjustable.

In an embodiment of the present invention, the driving body includes an installation groove recessed inward from the lower surface thereof, and the wheel module is coupled inside the installation groove, and a portion of the wheel part protrudes outside the installation groove.

In an embodiment of the present invention, the wheel module is detachably coupled to the installation groove, and when the wheel module is coupled to the driving body, an arrangement pattern of multiple wheel modules is adjustable.

In an embodiment of the present invention, the body includes a through-hole penetrating both ends in the vertical direction, and the connection part is arranged inside the through-hole and is rotatably arranged in the inner circumferential direction of the through-hole.

In an embodiment of the present invention, the connection part is rotatably arranged inside the through-hole in a third direction centered on a rotation shaft.

In an embodiment of the present invention, the connection part comprises a connection body, which includes a pair of curved parts curved to correspond to the inner surface shape of the through-hole and facing each other, and a pair of straight parts arranged between the pair of curved parts and extending parallel to each other.

In an embodiment of the present invention, a pair of auxiliary grounding parts are provided, and the pair of auxiliary grounding parts is arranged on both sides of the wheel body to face each other.

In an embodiment of the present invention, the wheel module includes: a first drive part arranged in the body and generating a driving force to rotate the connection part in the first direction; a second drive part arranged inside the wheel body and generating a driving force to rotate the wheel part in the second direction; and a third drive part disposed in the body and generating a driving force to rotate the connection part in the third direction.

In an embodiment of the present invention, the wheel module comprises a sensor unit for measuring the rotation angle of the wheel part and the rotation angle of the connection part.

In an embodiment of the present invention, the wheel module comprises a shock absorption part arranged at the upper portion of the body to absorb external shocks.

### Advantageous Effect

The wheel module and the drive device including the same according to embodiments of the present invention enable forward and backward movement by changing only the rotation direction of the wheel part through three-axis rotational motion of the wheel part, without the need to rotate the entire drive device itself. This allows the drive device and vehicle to turn with a small turning radius, facilitating direction changes in confined spaces while also reducing tire wear during vehicle turning. Additionally, by simply adjusting air pressure, the contact area between the auxiliary grounding part and the ground can be modified to control traction, enabling rapid braking in emergency situations.

The effects of the present invention are not limited to the above described effects and should be understood to include all effects that can be inferred from the configuration of the present invention described in the specification or claims.

### DESCRIPTION OF DRAWINGS

FIG. 1 is a perspective view illustrating a wheel module according to an embodiment of the present invention.

FIG. 2 is a perspective view illustrating a portion of the wheel module of FIG. 1.

FIG. 3 is a diagram illustrating the wheel module of FIG. 2 viewed from one direction.

FIG. 4 is a diagram illustrating the wheel module of FIG. 2 viewed from another direction.

FIG. 5 is a diagram illustrating the wheel module of FIG. 2 viewed from yet another direction.

FIG. 6 is a perspective view illustrating a wheel part according to an embodiment of the present invention.

FIG. 7 is a sectional view illustrating the wheel part of FIG. 6.

FIG. 8A illustrates one state of the wheel part of FIG. 6, and FIG. 8B illustrates another state of the wheel part of FIG. 6.

FIG. 9 is a perspective view illustrating a state in which the wheel part and a connection part are coupled according to an embodiment of the present invention.

FIG. 10 is a perspective view illustrating a drive device according to an embodiment of the present invention.

FIG. 11 illustrates an example of a vehicle equipped with the drive device according to an embodiment of the present invention.

FIG. 12A illustrates one state of a lower portion of the vehicle equipped with the drive device of FIG. 11, and FIG. 12B illustrates another state of the lower portion of the vehicle equipped with the drive device of FIG. 11.

### MODE FOR INVENTION

Hereinafter, the present invention will be described with reference to the accompanying drawings. However, the present invention may be embodied in various different forms, and thus, the embodiments described herein should not be construed as limiting. Furthermore, in the drawings, parts irrelevant to the description of the present invention are omitted for clarity, and similar reference numerals are assigned to similar components throughout the specification.

Throughout the specification, when a component is described as being “connected (coupled, in contact, or engaged)” with another component, it includes both cases where they are “directly connected” and where they are “indirectly connected” with another component interposed therebetween. Additionally, when a component is described as “including” a certain element, unless explicitly stated otherwise, it should be understood that the component may further include other elements in addition to the stated element.

The terms used in the present invention are used to describe specific embodiments of the present invention and there is no intent to limit the present invention. The singular form of the components may be understood into the plural form unless otherwise specifically stated in the context. It should be also understood that the terms of ‘include’ or ‘have’ in the specification are used to mean that there are characteristics, numbers, steps, operations, components, parts, or combinations of the steps, operations, components and parts described in the specification and there is no intent to exclude existence or possibility of other characteristics, numbers, steps, operations, components, parts, or combinations of the steps, operations, components and parts.

Hereinafter, embodiments of the present invention will be described in detail with reference to the accompanying drawings,

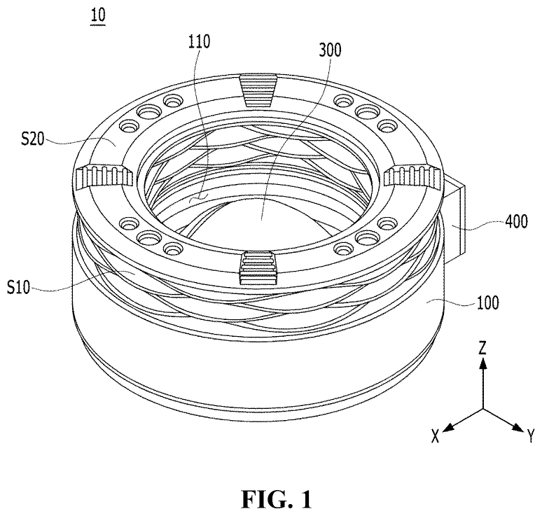

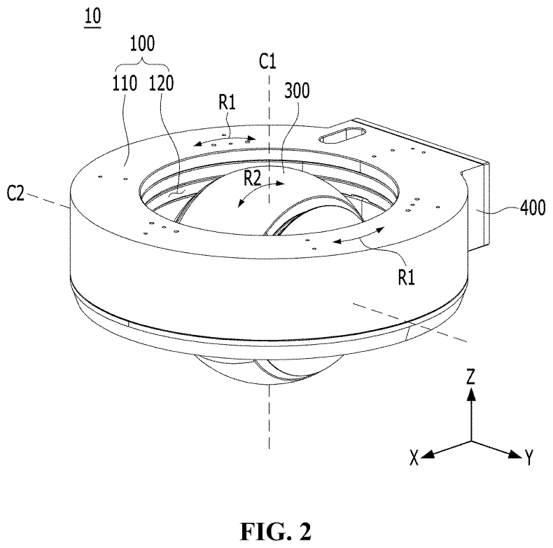

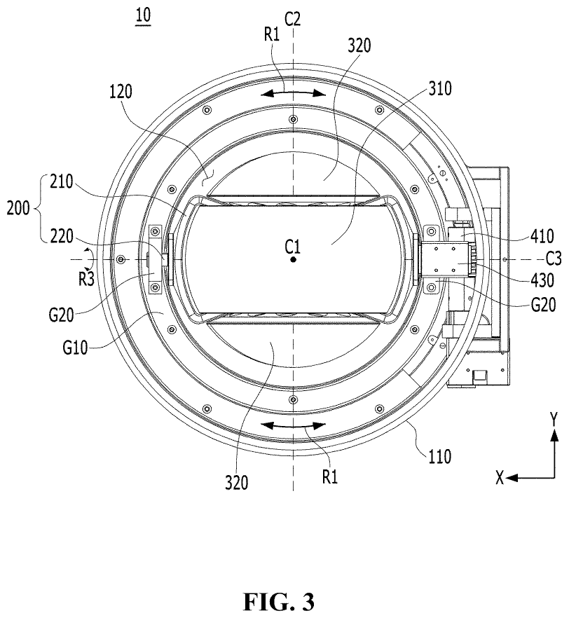

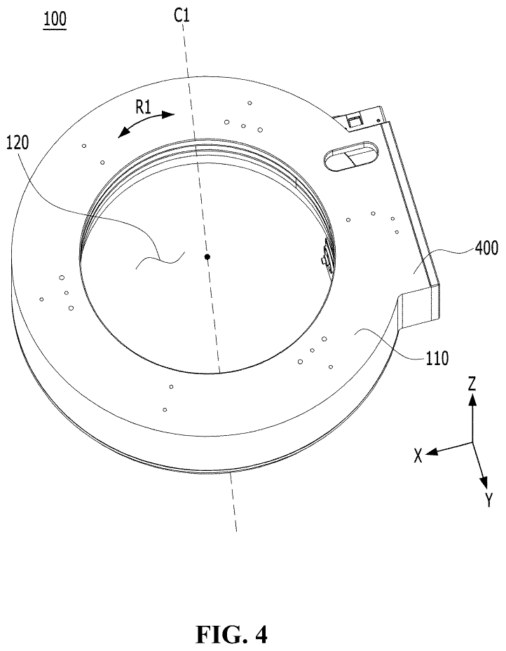

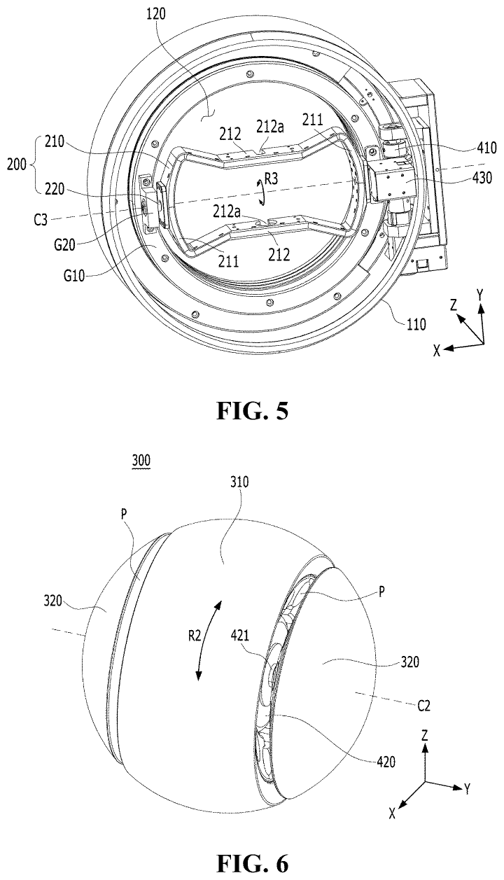

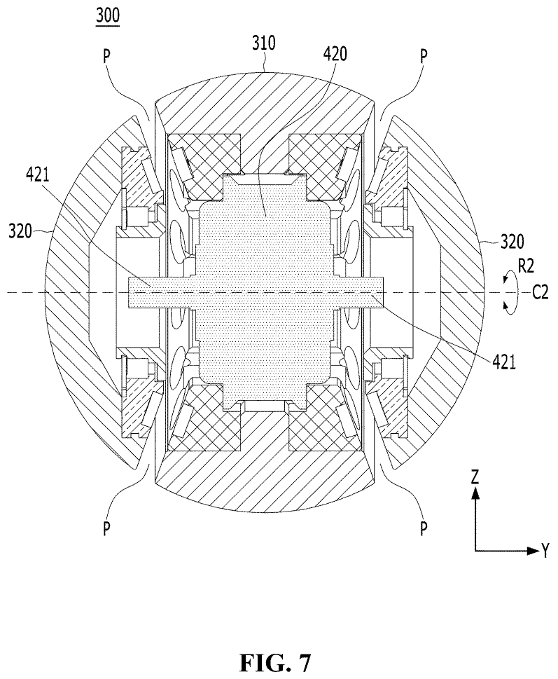

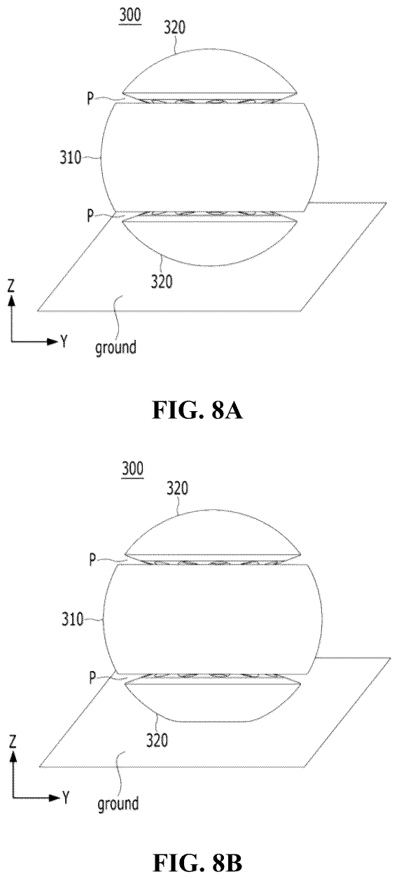

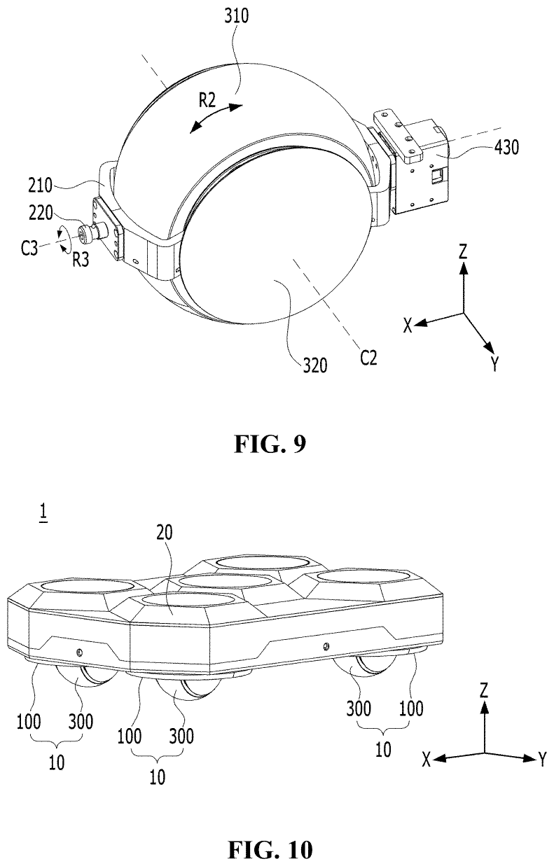

FIG. 1 is a perspective view illustrating a wheel module according to an embodiment of the present invention, FIG. 2 is a perspective view illustrating a portion of the wheel module of FIG. 1, FIG. 3 is a diagram illustrating the wheel module of FIG. 2 viewed from one direction, FIG. 4 is a diagram illustrating the wheel module of FIG. 2 viewed from another direction, FIG. 5 is a diagram illustrating the wheel module of FIG. 2 viewed from yet another direction, FIG. 6 is a perspective view illustrating a wheel part according to an embodiment of the present invention, FIG. 7 is a sectional view illustrating the wheel part of FIG. 6, FIG. 8A illustrates one state of the wheel part of FIG. 6, FIG. 8B illustrates another state of the wheel part of FIG. 6, and FIG. 9 is a perspective view illustrating a state in which the wheel part and a connection part are coupled according to an embodiment of the present invention.

Referring to FIGS. 1 to 9, the wheel module 10 can move a drive device 20 to which the wheel module 10 is mounted through a multi-axis rotational motion. In this case, the wheel module 10 may include a body 100, a connection part 200, a wheel part 300, and a drive part 400. Additionally, the wheel module 10 may further include a shock absorption part S10 and an intermediate connection part S20.

The body 100 is a part where other components of the wheel module 10 are arranged, and may include a support part 110 and a through-hole 120. In this instance, the support part 110 may have a cylindrical shape, as illustratively shown in the drawings, but the present invention is not limited thereto.

The through-hole 120 may be arranged in the support part 110. More specifically, the through-hole 120 may extend from the upper end to the lower end of the support part 110 in the vertical direction, for example, in the Z-axis direction. Accordingly, the through-hole 120 may be formed by penetrating the support part 110 in the vertical direction (Z-axis direction).

The through-hole 120 may accommodate a rotation part G10 and a connection protrusion member G20. In this case, the rotation part G10 is arranged at the lower end of the through-hole 120 and extends in a circumferential direction (R1 direction) of the through-hole 120, forming a ring shape where both ends meet. In this instance, the rotation part G10 may be arranged to rotate in a first direction (R1 direction). The rotation part G10 may be rotated by the rotational driving force generated by the first drive part 410.

The connection protrusion member G20 may be formed to protrude downward −Z-axis direction from the lower surface of the rotation part G10 as an embodiment. As described above, when the rotation part G10 rotates in the first direction (R1 direction), the connection protrusion member G20 may rotate together with the rotation part G10. At this time, the connection protrusion member G20 may be symmetrically arranged to face a third drive part 430 arranged on the lower surface of the rotation part G10.

The connection part 200 may connect the wheel part 300 to the body 100. In this case, the connection part 200 may be disposed in the body 100. More specifically, the connection part 200 may be arranged inside the through-hole 120. The connection part 200 may be rotatably coupled to the body 100 in the first direction (R1 direction). Here, the first direction (R1 direction) refers to the circumferential direction of the through-hole 120 or the circumferential direction of the body 100 when viewed from a direction parallel to the XY plane. The connection part 200 may include a connection body 210 and a first connection shaft 220.

The connection body 210 is a part where the wheel part 300, to be described later, is directly connected, and may be formed as a single frame or as multiple connected frames. In this instance, the connection body 210 may be arranged to be accommodated within the through-hole 120.

In one embodiment, the connection body 210 may include a pair of curved parts 211 and a pair of straight parts 212. In this case, the pair of curved parts 211 may be symmetrically arranged to face each other. The curved parts 211 may be curved in a shape corresponding to the inner surface shape of the through-hole 120. The pair of straight parts 212 may be spaced apart and extend parallel between the pair of curved parts 211. In this case, one end of each straight part 212 may be connected to one end of either curved part 211, while the other end of each straight part 212 may be connected to the other curved part 211.

The first connection shaft 220 may connect the connection body 210 to the body 100. The first connection shaft 220 may rotate the connection body 210 in a third direction (R3 direction) using the driving force generated by the third drive part 430, which will be described later.

In one embodiment, a pair of first connection shafts 220 may be provided. In this case, one of the pair of first connection shafts 220 (hereinafter, referred to as a first rotation shaft) may have one end coupled to one end of the connection body 210. The end of the connection body 210 where the first connection shaft 220 is coupled may be one of the pair of curved parts 211. The other end of the first connection shaft 220 may be rotatably connected to the connection protrusion member G20. Additionally, the other of the first connection shafts 220, hereinafter referred to as the second rotation shaft, may have one end coupled to the other end of the connection body 210. The end of the connection body 210 where the second first connection shaft 220 is coupled may be the other of the curved parts 211. The other end of the second first connection shaft 220 may be connected to the third drive part 430.

Accordingly, the first connection shaft 220 may rotate in the third direction (R3 direction) by the rotational driving force generated by the third drive part 430, and the connection body 210 and the first connection shaft 220 may rotate together in the same direction (R3 direction). Furthermore, since the connection body 210 is coupled to the rotation part G10 through the connection protrusion member G20 and the third drive part 430, as described above, the connection body 210 can rotate in the first direction (R1 direction) along with the rotation of the rotation part G10.

The wheel part 300 can move the wheel module 10 and the drive device 2 to which the wheel module 10 is mounted through multi-axis rotational motion. In this case, the wheel part 300 may include a wheel body 310 and an auxiliary grounding part 320.

The wheel body 310 has a tire part arranged on the outer side thereof, and a second drive part 420 may be arranged in a receiving space provided inside the tire part. In this case, the wheel body 310 may be configured, for instance, as an in-wheel motor system. Meanwhile, although a main tread part of a main tire part in the wheel body 310 is illustrated in the drawings without grooves, the present invention is not limited thereto, and various types of grooves may be formed on the ground contact surface of the tire part.

A portion of the wheel body 310 may be arranged inside the through-hole 120. More specifically, the upper portion of the wheel body 310 may be arranged within the through-hole 120. At this time, the lower portion of the wheel body 310 may be arranged outside the through-hole 120, protruding downward from the body 100 so that the lower portion of the wheel body can come into contact with the ground when the wheel module 10 is in operation.

The wheel body 310 may be rotatably coupled to the connection part 200 in the second direction (R2 direction). More specifically, the wheel body 310 may be accommodated between the pair of straight parts 212 provided in the connection body 210. In this case, the second drive part 420 may include a pair of second connection shafts 421. The pair of second connection shafts 421 may extend in opposite directions along the left-right direction (Y-axis direction or-Y-axis direction) from the second drive part 420, be inserted into connection holes 212a formed in the pair of straight parts 212, such that the wheel body 310 is coupled to the connection body 210. At this time, the second connection shafts 421 may be rotatably connected to the connection holes 212a in the second direction (R2 direction). Additionally, the ends of the pair of second connection shafts 421 may protrude outward from the adjacent straight parts 212 in the left-right direction (Y-axis direction or-Y-axis direction).

The auxiliary grounding part 320 may selectively ground to the surface of the ground as the wheel module 10 undergoes multi-axis rotational motion. An auxiliary tire part may be provided on the outer surface of the auxiliary grounding part 320. In this case, an auxiliary tread part of the auxiliary tire part may be made of a material different from that of the main tread part to provide higher grip force than the wheel body 310.

A pair of auxiliary grounding parts 320 may be provided. In this case, one of the pair of auxiliary grounding parts 320 may be connected to one end of the pair of second connection shafts 421, and the other auxiliary grounding part 320 may be connected to the other end of the second connection shafts 421. Accordingly, the pair of auxiliary grounding parts 320 may be arranged on both sides of the wheel body 310 to face each other. More specifically, the pair of auxiliary grounding parts 320 may be symmetrically arranged around the wheel body 310. At this time, a separation space P may be formed between each auxiliary grounding part 320 and the wheel body 310.

The internal pressure of the auxiliary grounding part 320 may be selectively adjusted. In one embodiment, the auxiliary grounding part 320 may be a pneumatic tire. In this case, the internal air pressure of the auxiliary grounding part 320 may be adjusted by controlling the amount of air inside the auxiliary grounding part 320. For example, an air injection/suction device (not shown) may be arranged within the receiving space of the wheel body 310 or the body 100. The air injection/suction device may inject air into or inhale the interior air from the auxiliary grounding part 320 to increase or decrease the internal air pressure.

While the wheel module 10 and the drive device 1 are moving, one of the pair of auxiliary grounding parts 320 may come into contact with the surface of the ground due to the rotation of the wheel part 300. At this time, as illustrated in FIG. 8A, the interior of the auxiliary grounding part 320 may be filled with a sufficient amount of air, maintaining a relatively high internal air pressure. Due to the air pressure, even when the auxiliary grounding part 320 is pressed by the load of the wheel module 10 or the drive device 1 as coming into contact with the surface of the ground, the volume or shape of the auxiliary grounding part 320 is not changed. Accordingly, the wheel part 300 can maintain a spherical shape during driving, preventing a decrease in driving performance.

On the other hand, as illustrated in FIG. 8b, when the wheel module 10 or the drive device 1 is stopped or parked, the wheel part 300 may rotate so that one of the pair of auxiliary grounding parts 320 comes into contact with the surface of the ground to inhale and discharge air from the interior of the auxiliary grounding part 320, thus reducing the internal pressure. As described above, in the relatively low internal pressure state, the auxiliary grounding part 320 getting in contact with the surface of the ground may be pressed by the load of the wheel module 10 and the drive device 1, such that at least a portion (for example, the contact area with the surface of the ground) may be flattened. As a result, the contact area between the auxiliary grounding part 320 and the ground increases, enhancing the grip force and improving parking and stopping stability.

As another embodiment, the auxiliary grounding part 320 may be an airless tire. In this case, the auxiliary grounding part 320 may undergo shape deformation through a mechanical method. For example, a pressing part (not shown) capable of reciprocating linear motion in one direction (Z-axis direction in FIG. 8) may be provided at the center (C2) of the auxiliary grounding part 320. In this case, as the pressing part moves in the inward direction of the auxiliary grounding part 320 (Z-axis direction in FIG. 8), the auxiliary tread around the pressing part may collapse inward together, transforming into a flat shape. When the pressing part moves again in the outward direction (−Z-axis direction in FIG. 8), the pressing force by the pressing part is released, and the shape of the auxiliary tread can be restored to the original hemispherical form thereof. However, the present invention is not limited to the above-described embodiments.

The drive part 400 may generate driving force for the rotational motion of the wheel module 10. The drive part 400 may include a first drive part 410, a second drive part 420, and a third drive part 430. At this time, since the rotational motion of the wheel part 300 by the second drive part 420 and the rotational motion of the connection part 200 by the third drive part 430 are the same as the above, redundant descriptions related to the above are omitted.

The first drive part 410 may be arranged in the body 100 and generate rotational driving force to rotate the connection part 200 in the first direction (R1 direction). More specifically, the first drive part 410 may change the rotation direction to the first direction (R1 direction) using a direction conversion member to rotate the rotation part G10 in the first direction (R1 direction). Accordingly, the connection part 200 coupled to the rotation part G10 may perform rotational motion in the first direction (R1 direction).

As described above, the wheel part 300 may rotate in the first direction (R1 direction) by the rotational motion of the rotation part G10, may rotate in the second direction (R2 direction) by the rotational motion of the wheel body 310, and may rotate in the third direction (R3 direction) by the rotational motion of the connection part 200, thereby enabling three-axis rotational motion. FIG. 10 is a perspective view illustrating a drive device according to an embodiment of the present invention.

Referring to FIG. 10, the drive device 1 may include a wheel module 10 and a driving body 20. Since the detailed description of the wheel module 10 is the same or similar to the described above, only the differences will be described.

The wheel module 10 may further include a lighting unit (not shown). In this case, a plurality of lighting units may be provided to emit different types of light. The plurality of lighting units may be installed at various locations of the body 100 to externally display the driving or braking status of the drive device 2, as well as warnings related to tire abnormalities.

The driving body 20 is a part where at least one wheel module 10 is mounted and may be formed by connecting a plurality of plates or as a single structure.

The driving body 20 may include an installation groove (not shown) recessed inward or upward (in the Z-axis direction) from the lower surface of the driving body 20. The wheel module 10 may be mounted in the installation groove. In this case, the upper portion of the wheel module 10 is coupled in a state accommodated within the installation groove, but the lower portion of the wheel module 10, that is, a portion of the wheel part 300, is arranged to protrude below the installation groove and may be grounded.

At least one installation groove may be provided. In one embodiment, if only one wheel module 10 is mounted on the drive device 2, one installation groove may be provided accordingly. In another embodiment, if multiple wheel modules 10 are mounted on the drive device 2, multiple installation grooves may be provided accordingly.

The wheel module 10 may be detachably coupled to the installation groove. Accordingly, the number and/or mounting position of the wheel modules 10 can be changed to adjust the arrangement pattern of the multiple wheel modules 10 according to the specifications or intended use of the drive device 2.

Referring again to FIG. 1, the shock absorption part S10 can absorb vertical shocks (in the Z-axis direction or −Z-axis direction) generated when the wheel module 10 is mounted on the drive device 2 and the drive device 2 is in motion. In this instance, the shock absorption part S10 may be arranged at the upper end of the body 100. Accordingly, when the wheel module 10 is mounted on the drive device 2, the shock absorption part S10 may be positioned between the wheel module 10 and the driving body 20, which will be described later. The shock absorption part S10 may be, for example, a suspension. The shock absorption part S10 can perform a buffering function between the wheel module 10 and the surface of the ground when the drive device 2 makes a sudden stop or turn, preventing damage and improving the grip force to the surface of the ground.

The intermediate connection part S20 is a part that couples the wheel module 10 to the driving body 20 and may be arranged at the upper portion of the shock absorption part S10. More specifically, the intermediate connection part S20 may include a coupling structure, such as a coupling groove or a coupling protrusion, at the top or side thereof for coupling with the driving body 20. In this case, the driving body 20 may include a coupling structure that is compatible with the coupling structure of the intermediate connection part S20. Through the coupling and separation between the coupling structure of the driving body 20 and the coupling structure of the intermediate connection part S20, the wheel module 10 can be selectively attached to or detached from the driving body 20.

Meanwhile, the wheel module 10 or the driving body 20 may be provided with a sensor unit for measuring a rotation angle of the wheel part 300 and/or a rotation angle of the connection part 200. By using the sensor unit, when the wheel module 10 undergoes multi-axis rotational motion, the degree of rotation of the wheel part 300, the position of the auxiliary grounding part 320, and the rotation angle of the connection body 210 can be determined.

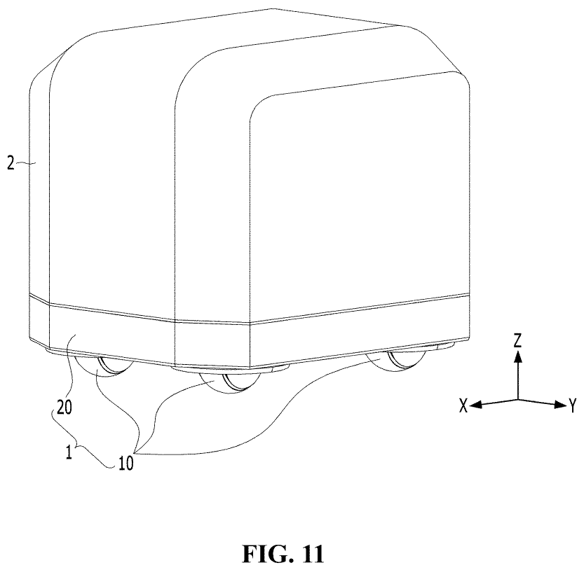

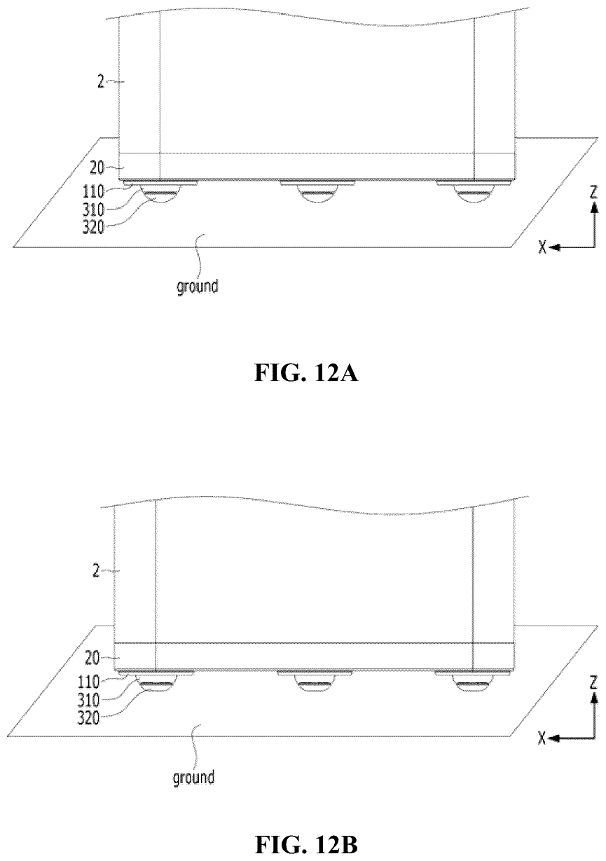

FIG. 11 illustrates an example of a vehicle equipped with the drive device according to an embodiment of the present invention, FIG. 12A illustrates one state of a lower portion of the vehicle equipped with the drive device of FIG. 11, and FIG. 12B illustrates another state of the lower portion of the vehicle equipped with the drive device of FIG. 11.

The drive device 1, which includes the above-described wheel module 10, can be installed in and driven by various types of vehicles or mobile robots, making it applicable to a wide range of platforms.

As illustrated in FIG. 11, the drive device 1 can replace conventional vehicle driving systems and be mounted on the lower portion of a vehicle 2, such as a bus. In this case, as described above, the number and/or mounting positions of the wheel modules 10 installed in the drive device 1 can be appropriately adjusted based on the specifications of the vehicle 2, such as the size and weight.

Referring to FIG. 12, when the vehicle 2 is in motion, the drive device 2 can increase the air pressure of the auxiliary grounding part 320, allowing the overall shape of the wheel part 300 to be spherical, thereby minimizing the contact area between the surface of the ground and the wheel part 300 to reduce friction. Conversely, when the vehicle 2 stops for parking or idling, the drive device 2 can rotate the connection part 200 to bring the auxiliary grounding part 320 into contact with the surface of the ground, and reduce the air pressure of the auxiliary grounding part 320 to change the shape thereof to increase the contact area with the surface of the ground, thereby enhancing the grip force between the ground and the wheel part 300. Thereafter, when the vehicle 2 resumes motion, the drive device can increase the air pressure of the auxiliary grounding part 320 again, and then, move the vehicle 2.

As described above, the wheel module 10 and the drive device 2 according to embodiments of the present invention enable forward and backward movement by simply changing the rotation direction of the wheel part 300 through the three-axis rotational motion of the wheel part 300, without requiring the rotation of the drive device 2, allow the drive device 2 and the vehicle 2 to turn with a small turning radius, thereby facilitating direction changes in confined spaces and reducing tire wear during the rotation of the vehicle. Additionally, by simply adjusting the air pressure, the wheel module 10 and the drive device 2 according to embodiments of the present invention can change the contact area between the auxiliary grounding part 320 and the ground to control the grip force, thus enabling rapid and easy braking in emergency situations.

The above description is only exemplary, and it will be understood by those skilled in the art that the invention may be embodied in other concrete forms without changing the technological scope and essential features. Therefore, the above-described embodiments should be considered only as examples in all aspects and not for purposes of limitation. For example, each component described as a single type may be realized in a distributed manner, and similarly, components that are described as being distributed may be realized in a coupled manner.

The scope of the present invention is defined by the appended claims, and encompasses all modifications or alterations derived from meanings, the scope and equivalents of the appended claims.

1. A wheel module comprising:
a body;
a connection part rotatably coupled to the body in a first direction; and
a wheel part including a wheel body rotatably coupled to the connection part in a second direction, and an auxiliary grounding part spaced apart from the wheel body, wherein the internal pressure of the auxiliary grounding part is selectively adjustable.

2. The wheel module according to claim 1, wherein the body includes a through-hole penetrating both ends in the vertical direction, and
wherein the connection part is arranged inside the through-hole and is rotatably arranged in the inner circumferential direction of the through-hole.

3. The wheel module according to claim 2, wherein the connection part is rotatably arranged inside the through-hole in a third direction centered on a rotation shaft.

4. The wheel module according to claim 2, wherein the connection part comprises a connection body, which includes a pair of curved parts curved to correspond to the inner surface shape of the through-hole and facing each other, and a pair of straight parts arranged between the pair of curved parts and extending parallel to each other.

5. The wheel module according to claim 1, wherein a pair of auxiliary grounding parts are provided, and
wherein the pair of auxiliary grounding parts are arranged on both sides of the wheel body to face each other.

6. The wheel module according to claim 3, further comprising:
a first drive part arranged in the body and generating a driving force to rotate the connection part in the first direction;
a second drive part arranged inside the wheel body and generating a driving force to rotate the wheel part in the second direction; and
a third drive part arranged in the body and generating a driving force to rotate the connection part in the third direction.

7. The wheel module according to claim 1, further comprising:
a sensor unit for measuring a rotation angle of the wheel part and a rotation angle of the connection part.

8. The wheel module according to claim 1, further comprising:
a shock absorption part arranged at the upper portion of the body to absorb external shocks.

9. A drive device comprising:
a wheel module; and
a driving body to which at least one wheel module is coupled at a lower portion,
wherein the wheel module comprises:
a body;
a connection part rotatably coupled to the body in a first direction; and
a wheel part including a wheel body rotatably coupled to the connection part in a second direction, and an auxiliary grounding part spaced apart from the wheel body, wherein the internal pressure of the auxiliary grounding part is selectively adjustable.

10. The drive device according to claim 9, wherein the driving body includes an installation groove recessed inward from the lower surface thereof; and
wherein the wheel module is coupled inside the installation groove, and a portion of the wheel part protrudes outside the installation groove.

11. The drive device according to claim 10, wherein the wheel module is detachably coupled to the installation groove, and
wherein when the wheel module is coupled to the driving body, an arrangement pattern of multiple wheel modules is adjustable.

12. The drive device according to claim 9, wherein the body includes a through-hole penetrating both ends in the vertical direction, and
wherein the connection part is arranged inside the through-hole and is rotatably arranged in the inner circumferential direction of the through-hole.

13. The drive device according to claim 12, wherein the connection part is rotatably arranged inside the through-hole in a third direction centered on a rotation shaft.

14. The drive device according to claim 12, wherein the connection part comprises a connection body, which includes a pair of curved parts curved to correspond to the inner surface shape of the through-hole and facing each other, and a pair of straight parts arranged between the pair of curved parts and extending parallel to each other.

15. The drive device according to claim 9, wherein a pair of auxiliary grounding parts are provided, and
wherein the pair of auxiliary grounding parts is arranged on both sides of the wheel body to face each other.

16. The drive device according to claim 13, wherein the wheel module comprises:
a first drive part arranged in the body and generating a driving force to rotate the connection part in the first direction;
a second drive part arranged inside the wheel body and generating a driving force to rotate the wheel part in the second direction; and
a third drive part disposed in the body and generating a driving force to rotate the connection part in the third direction.

17. The drive device according to claim 9, wherein the wheel module comprises a sensor unit for measuring the rotation angle of the wheel part and the rotation angle of the connection part.

18. The drive device according to claim 9, wherein the wheel module comprises a shock absorption part arranged at the upper portion of the body to absorb external shocks.
